(19) United States
(12) Patent Application Publication
(10) Pub. No.: US 2006/0222907 A1
(43) Pub. Date: Oct. 5, 2006

(54) Magnetic recording medium having an atmospheric plasma modified substrate

(75) Inventor: Chur K. Vang, Oakdale, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/092,237

(22) Filed: Mar. 29, 2005

(51) Int. Cl. G11B 5/706; B05D 5/12; B05D 3/00

(52) U.S. Cl. 428/847.2; 428/848.8; 427/532; 427/127

(57) ABSTRACT

A magnetic recording medium having a polyester substrate with at least one magnetic recording layer coated thereon, wherein the substrate is a polyester film which has been modified by atmospheric plasma treatment prior to coating. The treated substrate film exhibits a contact angle of at least about 20 degrees less than the contact angle of an unmodified polyester film and has an average peel adhesion to a magnetic recording coating of at least about 0.2 N/mm.

### THE FIELD OF THE INVENTION

The present invention relates generally to a magnetic recording medium having a substrate with improved adhesion. Specifically, the invention relates to a magnetic recording medium which has been subjected to an atmospheric plasma surface treatment prior to having any recording layer coated thereon.

### BACKGROUND OF THE INVENTION

Magnetic recording media are widely used in audio tapes, video tapes, computer tapes, disks and the like. Magnetic media may use thin metal layers as the recording layers, or may comprise coatings containing magnetic particles as the recording layer. The latter type of recording media employs particulate materials such as ferromagnetic iron oxides, chromium oxides, ferromagnetic alloy powders and the like dispersed in binders and coated on a substrate. In general terms, such magnetic recording media generally comprise a magnetic layer coated onto at least one side of a non-magnetic substrate (e.g., a film for magnetic recording tape applications). The formulation for the magnetic coating is optimized to maximize the performance of the magnetic recording medium.

Magnetic recording media also typically have a backside coating applied to the opposing side of the non-magnetic substrate in order to improve the durability, conductivity, and tracking characteristics of the media.

Particulate based magnetic recording media include a granular pigment. Popular pigments are metal oxides, ferromagnetic metal oxides, and ferromagnetic metal alloys. Different pigments have different surface properties; the metal particles often have a strongly basic surface. Recording media often utilize alpha hematite (α-Fe₂O₃) particles in the formulations such as gamma iron oxide (g-Fe₂O₃), magnetite (Fe₃O₄), cobalt-doped iron oxides, or ferromagnetic metal or metal alloy powders, along with carbon black particles.

Magnetic recording layers typically include a binder composition. The binder composition performs such functions as dispersing the particulate materials, increasing adhesion between layers and to the substrate, improving gloss and the like. As might be expected, the formulation specifics as well as coating of the binder compositions to an appropriate substrate are highly complex, and vary from manufacturer to manufacturer; however, most binders include such materials as thermoplastic materials.

The substrates useful in such magnetic recording media are typically polymeric films. Such films have only a limited affinity for the magnetic recording layers which are coated onto at least one surface of the substrate in order to create the medium. Surface treatments of various types have been employed in order to improve the adhesion between the substrate and the coating. However, many otherwise desirable surface treatments require the use of elevated temperatures which negatively impacts the polymeric films themselves. Other surface treatments such as organic priming and corona treatments are useful but extremely expensive and require high energy sources for treatment application. Additionally, corona treatment does not produce a uniform gas discharge which can lead to untreated surface micro-regions, lessening adhesion benefits for the substrate and the resultant magnetic recording medium.

It would be desirable have a magnetic recording medium wherein the substrate has a surface treatment thereon for improved adhesion to the magnetic layer or sublayer, if present. It would also be desirable for such treatment to be relatively low cost, applicable at ambient temperatures, and provide an extended time for the benefit of the treatment to remain on the substrate film.

It has now been discovered that an atmospheric plasma treatment applied to a polyester substrate will provide improved adhesion between the magnetic layer coating or the sublayer coating (if present) of a magnetic recording medium. Such plasma treatment also allows the film to be stored after treatment prior to use without losing the treatment benefits.

### SUMMARY OF THE INVENTION

The invention provides a magnetic recording medium having a polyester substrate with at least one magnetic recording layer coated thereon, where the polyester film substrate has been modified by atmospheric plasma treatment prior to coating.

In one embodiment, the invention provides a magnetic recording medium wherein said magnetic recording layer has a mean peel adhesion to said substrate of at least about 0.2 N/mm.

In another embodiment, the invention provides a magnetic recording medium with a substrate having been modified by atmospheric plasma treatment wherein the atmospheric plasma treatment is performed completely at ambient temperatures.

In another embodiment, the invention provides a magnetic recording medium wherein the substrate is formed from a polyester film selected from polyethylene terephthalate and polyethylene naphthalate.

In yet another embodiment, the invention provides a magnetic recording medium wherein said atmospheric plasma treatment uses at least one gas selected from helium, oxygen, CO₂, N₂, ammonia, and mixtures thereof.

The magnetic recording medium of the invention may be a magnetic recording tape.

The invention also provides a polyester film suitable for use as a substrate for a magnetic recording medium, said film having been modified by atmospheric plasma treatment, said film exhibiting a contact angle of at least about 20 degrees less than the contact angle of an unmodified polyester film and has an average peel adhesion to a magnetic recording coating of at least about 0.2 N/mm.

The invention provides a method for making a magnetic recording medium comprising

These terms when used herein have the following meanings.

1. The term “coating composition” means a composition suitable for coating onto a substrate.

2. The terms “layer” and “coating” are used interchangeably to refer to a coated composition.

3. The term “coercivity” means the intensity of the magnetic field needed to reduce the magnetization of a ferromagnetic material to zero after it has reached saturation, taken at a saturation field strength of 10,000 Oersteds.

4. The term “Oersted,” abbreviated as Oe, refers to a unit of magnetic field in a dielectric material equal to 1/μ Gauss, where μ is the magnetic permeability.

5. The terms “layer” or “coating” are used interchangeably to refer to a coated composition, which may be the result of one or more evaporative processes and one or more passages through the coating apparatus.

6. The term “plasma” means a cloud of particles containing neutral, positive and negatively charged ions which exhibits the properties of a gas.

7. The term “sublayer” means a layer coated prior to the magnetic recording layer. It may be coated directly onto the substrate or atop another sublayer.

### BRIEF DESCRIPTION OF THE DRAWINGS

FIG. 1 is a graph showing a comparison of contact angles of treated and nontreated poly(ethylene terephthalate) film.

FIGS. 2A and 2B are a side-by-side comparison of the surface of a polyester film modified by atmospheric plasma treatment and organically primed polyester film.

### DETAILED DESCRIPTION OF THE PREFERRED EMBODIMENTS

The following detailed description describes certain embodiments and is not to be taken in a limiting sense. The scope of the present invention is defined by the appended claims.

The invention provides a magnetic recording medium including a non-magnetic substrate having a magnetic coating on the front side of the substrate wherein the substrate has been subjected to an atmospheric plasma treatment prior to coating. The magnetic layer contains at least one metallic particulate pigment and a binder system therefor. The magnetic recording medium may be a magnetic recording tape, and may contain only a single coating, i.e., a magnetic recording layer, or may contain multiple layers.

Substrate and Atmospheric Plasma Surface Treatment

The substrate which is to be coated with the magnetic recording layer may be any non-magnetic substrate, but is preferably a flexible polymeric substrate having a thickness of from about 4 micrometers to about 60 micrometers. Useful substrates include polyesters such as polyethylene terephthalate, polyethylene naphthalate and the like.

The unprimed substrate is subjected to atmospheric plasma treatment prior to being used to form a magnetic recording medium, particularly a magnetic recording tape. Atmospheric plasma treatment is treatment via the ionization of a gas. Plasma treatment is a low temperature, low-pressure discharge consisting of reactive gas molecules, called charge molecules, which are distributed uniformly toward the film, and which cause a reaction between the gaseous species and the substrate, which leads to a chemical modification on the substrate surface. This process may be performed entirely at ambient temperatures, and does not require the use of a vacuum chamber or a high energy source. The atmospheric plasma treatment uses at least one gas selected from helium, oxygen, CO₂, N₂, ammonia, and mixtures thereof.

The atmospheric plasma system may be a stand-alone unit used off-line or the unit may be installed directly in-line with the coating process. The latter of the two is more advantageous due in part to the reduction of surface debris that may be attracted to the surface treated substrates.

The atmospheric plasma treatment is typically performed as the film moves on a conveyer having an average speed between about 100 ft/minute and 1000 ft/minute. Power settings on the plasma equipment can be from 1 kV up to about 5 kV, and is typically around 2kV-much lower than corona treatments, which require power of about 10 kV to 20 kV for application. The plasma equipment can operate from 1 kW up to about 3 kW, and is typically set at about 2 kW.

The surface modification alters the surface tension of the film to provide better wettability to the surface. The contact angle of the film differs by at least about 20 degrees, i.e., it is at least about 20 degrees less than the contact angle of an untreated film.

Magnetic Recording Layer(s)

In accordance with the current invention, the magnetic recording medium includes at least one magnetic recording layer. The magnetic recording layer or layers are thin, being preferably from about 0.025 micron (1), or one microinch, to about 0.25μ, or about 10 microinches in thickness, preferably up to about 0.20μ. Magnetic recording layers of the invention include at least one type of magnetic particulate material. Useful magnetic pigments have compositions including, but not limited to, metallic iron and/or alloys of iron with cobalt and/or nickel, and magnetic or non-magnetic oxides of iron, other elements, or mixtures thereof. Alternatively, the magnetic particles can be composed of hexagonal ferrites such as barium ferrites. In order to improve the required characteristics, the preferred magnetic powder may contain various additives, such as semi-metal or non-metal elements and their salts or oxides such as Al, Nd, Si, Co, Y, Ca, Mg, Mn, Na, etc. The selected magnetic powder may be treated with various auxiliary agents before it is dispersed in the binder system, resulting in the primary magnetic metal particle pigment. Preferred pigments have an average particle length of about 150 nanometers (nm) or less. Such pigments are available from companies such as Toda Kogyo, Kanto Denka Kogyo, and Dowa Mining Company. As noted above, pigments useful in magnetic recording media of the invention have a minimum coercivity of at least about 2000 Oe.

The magnetic layer may also include soft spherical particles. Most commonly these particles are comprised of carbon black. A small amount, preferably less than about 3%, of at least one relatively large particle carbon material may also be included, preferably a material that includes spherical carbon particles. The large particle carbon materials have a particle size on the order of from about 50 to about 500 nm, more preferably from about 70 to about 300 nm. Spherical large carbon particle materials are known and commercially available, and in commercial form can include various additives such as sulfur to improve performance. The remainder of the carbon particles present in the layer are small carbon particles, i.e., the particles have a particle size on the order of less than 100 nm, preferably less than about 50 nm.

The Sublayer

The sublayer, or lower layer of a multi-layer magnetic tape, is essentially non-magnetic and typically includes a non-magnetic or soft magnetic powder having a coercivity of less than 300 Oe and a resin binder system. By forming the sublayer to be essentially non-magnetic, the electromagnetic characteristics of the upper magnetic layer are not adversely affected. However, to the extent that it does not create any adverse affect, the sublayer may contain a small amount of a magnetic powder.

The pigment or powder incorporated in the sublayer includes at least a primary pigment material and conductive carbon black. The primary pigment material consists of a particulate material, or “particle” selected from non-magnetic particles such as iron oxides, titanium dioxide, titanium monoxide, alumina, tin oxide, titanium carbide, silicon carbide, silicon dioxide, silicon nitride, boron nitride, etc., and soft magnetic particles having a coercivity of less than 300 Oe. Optionally these primary pigment materials can be provided in a form coated with carbon, tin, or other electroconductive material and employed as sublayer pigments. In a preferred embodiment, the primary sublayer pigment material is a carbon-coated hematite material (a-iron oxide), which can be acidic or basic in nature. Preferred alpha-iron oxides are substantially uniform in particle size, or a metal-use starting material that is dehydrated by heating, and annealed to reduce the number of pores. After annealing, the pigment is ready for surface treatment, which is typically performed prior to mixing with other layer materials such as carbon black and the like. Alpha-iron oxides are well known and are commercially available from Dowa Mining Company, Toda Kogyo, KDK, Sakai Chemical Industry Co, and others. The primary pigment preferably has an average particle size of less than about 0.25 μm, more preferably less than about 0.15 μm.

Conductive carbon black material provides a certain level of conductivity so as to prohibit the front coating from charging with static electricity and further improves smoothness of the surface of the upper magnetic layer formed thereon. The conductive carbon black material is preferably of a conventional type and is widely commercially available. In one preferred embodiment, the conductive carbon black material has an average particle size of less than about 20 nm, more preferably about 15 nm. In the case where the primary pigment material is provided in a form coated with carbon, tin or other electroconductive material, the conductive carbon black is added in amounts of from about 1 to about 5 parts by weight, more preferably from about 1.5 to about 3.5 parts by weight, based on 100 parts by weight of the primary sublayer pigment material. In the case where the primary pigment material is provided without a coating of electroconductive material, the conductive carbon black is added in amounts of from about 5 to about 18 parts by weight, more preferably from about 8 to about 12 parts by weight, based on 100 parts by weight of the primary sublayer pigment material. The total amount of conductive carbon black and electroconductive coating material in the sublayer is preferably sufficient to provide a resistivity at or below about 1×10⁸ ohm/cm².

The sublayer can also include additional pigment components such as an abrasive or head cleaning agent (HCA). One preferred HCA component is aluminum oxide. Other abrasive grains such as silica, ZrO₂, Cr₂O₃, etc., can be employed.

The binder system or resin associated with the sublayer preferably incorporates at least one binder resin, such as a thermoplastic resin, in conjunction with other resin components such as binders and surfactants used to disperse the HCA, a surfactant (or wetting agent), and one or more hardeners. In one preferred embodiment, the binder system of the sublayer includes a combination of a primary polyurethane resin and a vinyl chloride resin, a vinyl chloride-vinyl acetate copolymer, vinyl chloride-vinyl acetate-vinyl alcohol copolymer, vinyl chloride-vinyl acetate-maleic anhydride, or the like. In an alternate embodiment, the vinyl resin is a non-halogenated vinyl copolymer. Useful vinyl copolymers include copolymers of monomers comprising (meth)acrylonitrile; a nonhalogenated, hydroxyl functional vinyl monomer; a non-halogenated vinyl monomer bearing a dispersing group, and one or more nonhalogenated nondispersing vinyl monomers. A preferred nonhalogenated vinyl copolymer is a copolymer of monomers comprising 5 to 40 parts of (meth)acrylonitrile, 30 to 80 parts of one or more nonhalogenated, nondispersing, vinyl monomers, 5 to 30 parts by weight of a nonhalogenated hydroxyl functional, vinyl monomer, and 0.25 to 10 parts of a nonhalogenated, vinyl monomer bearing a dispersing group.

Examples of useful polyurethanes include polyester-polyurethane, polyether-polyurethane, polycarbonate-polyurethane, polyester-polycarbonate-polyurethane, and polycaprolactone-polyurethane. Resins such as bisphenol-A epoxide, styrene-acrylonitrile, and nitrocellulose may also be acceptable.

In a preferred embodiment, a primary polyurethane binder is incorporated into the sublayer in amounts of from about 4 to about 10 parts by weight, and preferably from about 6 to about 8 parts by weight, based on 100 parts by weight of the primary sublayer pigment. In a preferred embodiment, the vinyl binder or vinyl chloride binder is incorporated into the sublayer in amounts of from about 7 to about 15 parts by weight, and preferably from about 10 to about 12 parts by weight, based on 100 parts by weight of the primary sublayer pigment.

The binder system further preferably includes an HCA binder used to disperse the selected HCA material, such as a polyurethane paste binder (in conjunction with a pre-dispersed or paste HCA). Alternatively, other HCA binders compatible with the selected HCA format (e.g., powder HCA) are acceptable.

The binder system may also contain a conventional surface treatment agent. Known surface treatment agents, such as phenylphosphonic acid (PPA), 4-nitrobenzoic acid, and various other adducts of sulfuric, sulfonic, phosphoric, phosphonic, and carboxylic acids are acceptable.

The binder system may also contain a hardening agent such as isocyanate or polyisocyanate. In a preferred embodiment, the hardener component is incorporated into the sublayer in amounts of from about 2 to about 5 parts by weight, and preferably from about 3 to about 4 parts by weight, based on 100 parts by weight of the primary sublayer pigment.

The sublayer may further contain one or more lubricants such as a fatty acid and/or a fatty acid ester. The incorporated lubricant(s) exist throughout the front coating and, importantly, at the surface of the upper layer. The lubricant(s) reduces friction to maintain smooth contact with low drag, and protects the media surface from wear. Thus, the lubricant(s) provided in both the upper and sublayers are preferably selected and formulated in combination. By way of background, conventional magnetic recording tape formulations employ technical grade fatty acids and fatty acid esters as the lubricant(s). It has surprisingly been found that these technical grade lubricant materials contribute to formation of sticky debris in the front coating due to migration of impurities to the front coating surface. This debris, in turn, can lead to poor tape performance, due to contamination of recording heads and other media transport surfaces, interference with lubricity of the medium in transport causing excessive frictional drag, and media wear.

In a preferred embodiment, the sublayer includes stearic acid that is at least 90 percent pure as the fatty acid. Although technical grade acids and/or acid esters can also be employed for the lubricant component, incorporation of high purity lubricant materials ensures robust performance of the resultant medium. Alternatively, other acceptable fatty acids include myristic acid, palmitic acid, oleic acid, etc., and their mixtures. The sublayer formulation can further include a fatty acid ester such as butyl stearate, isopropyl stearate, butyl oleate, butyl palmitate, butylmyristate, hexadecyl stearate, and oleyl oleate. The fatty acids and fatty acid esters may be employed singly or in combination. In a preferred embodiment, the lubricant is incorporated into the sublayer in an amount of from about 1 to about 10 parts by weight, and preferably from about 1 to about 5 parts by weight, based on 100 parts by weight parts of the electroconductive-coated primary sublayer pigment.

The materials for the sublayer are mixed with the surface treated primary pigment and the sublayer is coated to the substrate. Useful solvents associated with the sublayer coating material preferably include cyclohexanone (CHO), with a preferred concentration of from about 5% to about 50%, methyl ethyl ketone (MEK) preferably having a concentration of from about 30% to about 90%, and toluene (Tol), of concentrations from about 0% to about 40%. Alternatively, other ratios can be employed, or even other solvents or solvent combinations including, for example, xylene, tetrahydrofuran, and methyl amyl ketone, are acceptable.

Back Coat

The back coat is generally of a type conventionally employed, and thus primarily consists of a soft (i.e., Moh's hardness <5) non-magnetic particle material such as carbon black or silicon dioxide particles. In one embodiment, the back coat layer comprises a combination of two kinds of carbon blacks, including a primary, small carbon black component and a secondary, large texture carbon black component, in combination with appropriate binder resins. The primary, small carbon black component preferably has an average particle size on the order of from about 10 to about 25 nm, whereas the secondary, large carbon component preferably has an average particle size on the order of from about 50 to about 300 nm. As is known in the art, back coat pigments dispersed as inks with appropriate binders, surfactant, ancillary particles, and solvents are typically purchased from a designated supplier. In a preferred embodiment, the back coat binder includes at least one of: a polyurethane polymer, a phenoxy resin, or nitrocellulose added in an amount appropriate to modify coating stiffness as desired.

### EXAMPLES

Atmospheric plasma treatment was carried out using the PlasmaTreat3™ System manufacture by Enercon Industries. For the modification process, mixtures of helium and oxygen gas were used. Line speed of the treatment was set at 100 ft/min with a power setting at 2 KV. Surface characterization of plasma treated and non-plasma treated and uncoated PET films were evaluated using contact angle measurement, AFM, and XPS analysis.

### Contact Angle Measurement

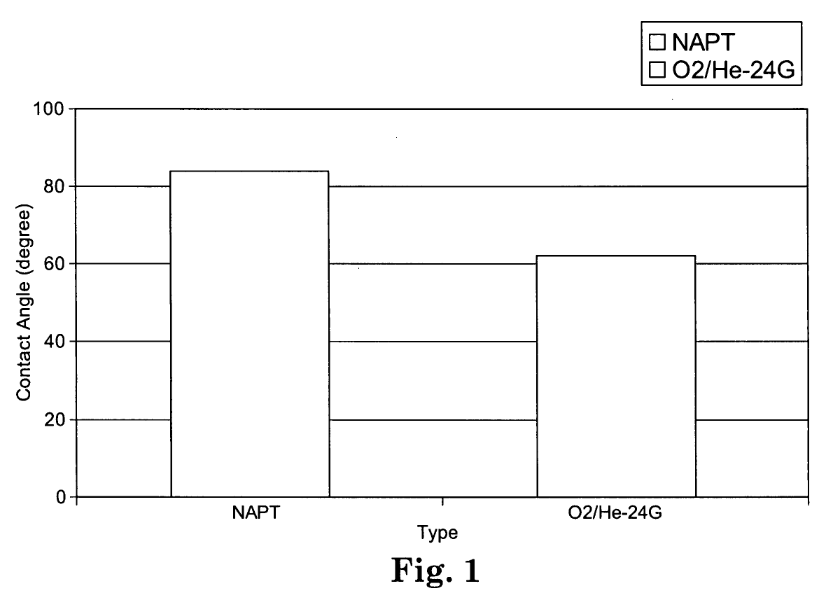

Contact angle measurement was carried out using the FTA200 equipped with video capture capability. Contact angle results are provided in FIG. 1. It is obvious from the figure that upon plasma treating the PET film, a difference of about ˜22 degree of the contact angle was observed. This reduction indicates that the surface chemical modification has taken place and that the surface tension has altered indicating better wettability of the film surfaces. Clearly, plasma treating the surface has brought about a chemical change to the PET surface.

### YPS Analysis

To illustrate surface chemical changes, XPS was utilized. Table 1 illustrates the changes of surface chemistry for plasma treated and non-plasma treated PET 5 film. According to survey scan, a higher oxygen concentration, lower carbon concentrations, and the presence of nitrogen was observed for plasma treated film (N32J-APT). High resolution spectra were also carried out and curve fitting from these spectra further indicated that the N32J-APT sample had lower C—C,H and aromatic satellite intensity while a high O═C—), N and C—O, N intensity were 10 observed. With a higher oxygen content, better wettability should be observed which is based on the previous contact angle results.

TABLE 1
C1s Chemistry from Curve Fitting (% of C)

| | % Area | % Are | % Area | % Are |
|---|---|---|---|---|
| AreaComment | C—C, H | C— | O═C— | arom. |
| N32J-NO-APT (45° | 58.6 | 21.5 | 15.9 | 4.0 |
| N32J-APT (45° TOA) | 52.9 | 24.6 | 19.4 | 3.1 |
| N32J-NO-APT (20° | 59.4 | 19.6 | 16.6 | 4.5 |
| N32J-APT (20° TOA) | 51.9 | 25.2 | 19.1 | 3.7 |

O1s Chemistry from Curve Fitting (% of O)

| | % Area | % Are |
|---|---|---|
| AreaComment | C—O | C═O |
| N32J-NO-APT (45° | 48.9 | 51.1 |
| N32J-APT (45° TOA) | 47.9 | 52.1 |
| N32J-NO-APT(20° TOA) | 48.7 | 51.3 |
| N32J-APT (20° TOA) | 48.8 | 51.2 |

### AFM Analysis

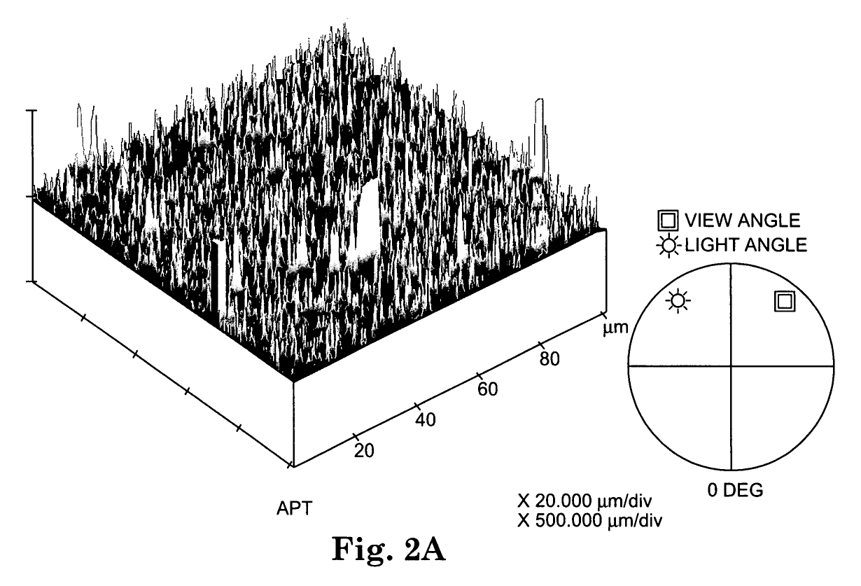

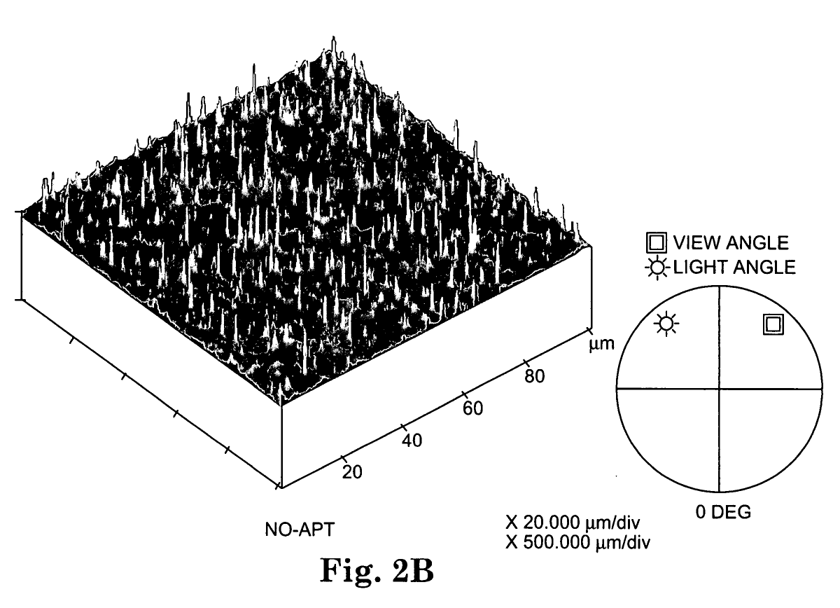

AFM analysis of the treated and non-treated PET film is depicted in FIGS. 2A and 2B. According to AFM analysis, the treated film (N32J-APT) appeared to have more uniform distribution of surface topography. This uniform hill and valley provides a clear indication of the uniformity of the plasma treatment. This needle-like surface structure could serve as sites for bonding as well. Based on these surface structures, a higher surface roughness (RA=20 nm) was observed for N32J-APT film (FIG. 2A). In fact, surface roughness for treated film is twice that of non-treated film (RA=10 nm). The rougher but uniform surface structures are unique to creating enhanced surface adhesion.

### Coating Adhesion

Peel adhesion as measured by an Instron® was tested for plasma treated (APT) and organically primed PET film with PVC magnetic tape coating is illustrated in Table 2. As was stated earlier, it is desirable to compare and contrast any differences between plasma treated and organically primed substrate with respect to surface adhesion. According to the peel test, the amount of load required to remove the magnetic coating from the substrate were comparable to one another for both organically primed and APT treated surface.

TABLE 2

| | | | | Average/ | |
|---|---|---|---|---|---|
| | Average | Average | | width | Average |
| | Load/width | Load | | [10-50 | Load |
| | (10-50 mm) | 10-50 | Maximum | mm] | [10-50 |
| | (N/mm) | mm (N) | Load (N) | (lbf/in) | mm] (lbf) |
| Organically | | | | | |
| Primed | | | | | |
| 24 G PET | | | | | |
| Film/PVC | | | | | |
| 1 | 0.21 | 2.73 | 4.07 | 1.23 | 0.61 |
| 2 | 0.25 | 3.21 | 4.29 | 1.44 | 0.72 |
| 3 | 0.22 | 2.77 | 4.48 | 1.25 | 0.62 |
| Mean | 0.23 | 2.90 | 4.28 | 1.31 | 0.65 |
| S.D. | 0.02 | 0.27 | 0.21 | 0.12 | 0.06 |
| Range | 0.04 | 0.48 | 0.41 | 0.22 | 0.11 |
| APT | | | | | |
| Treated | | | | | |
| 24 G PET | | | | | |
| Film/PVC | | | | | |
| 1 | 0.22 | 2.80 | 4.78 | 1.26 | 0.63 |
| 2 | 0.21 | 2.67 | 3.84 | 1.20 | 0.60 |
| 3 | 0.21 | 2.65 | 3.79 | 1.19 | 0.60 |
| Mean | 0.21 | 2.71 | 4.14 | 1.22 | 0.61 |
| S.D. | 0.01 | 0.06 | 0.56 | 0.04 | 0.02 |
| Range | 0.01 | 0.15 | 0.99 | 0.07 | 0.03 |

What is claimed is:

1. A polyester film suitable for use as a substrate for a magnetic recording medium, said film having at least one surface modified by atmospheric plasma treatment, said film exhibiting a contact angle of at least about 20 degrees less than the contact angle of an unmodified polyester film and has an average peel adhesion to a magnetic recording coating of at least about 0.2 N/mm.

2. A polyester film according to claim 1, wherein said atmospheric plasma treatment is performed completely at ambient temperatures.

3. A polyester film according to claim 1, wherein said atmospheric plasma treatment uses at least one gas selected from helium, oxygen, CO₂, N₂, ammonia, and mixtures thereof.

4. A polyester film according to claim 1, wherein said atmospheric plasma treatment is performed as said film moves on a conveyer having an average speed between about 100 ft/minute and 1000 ft/minute.

5. A polyester film according to claim 1 selected from the group consisting of polyethylene terephthalate and polyethylene naphthalate.

6. A magnetic recording medium having a polyester substrate with at least one magnetic recording layer coated thereon, said substrate being a polyester film having at least one surface modified by atmospheric plasma treatment prior to coating wherein said magnetic recording layer has a mean peel adhesion to said substrate of at least about 0.2 N/mm.

7. A magnetic recording medium according to claim 6, wherein said medium is a magnetic recording tape.

8. A magnetic recording medium according to claim 6, wherein said substrate is formed from a polyester film selected from the group consisting of polyethylene terephthalate and polyethylene naphthalate.

9. A magnetic recording medium according to claim 6, wherein said atmospheric plasma treatment is performed completely at ambient temperatures.

10. A magnetic recording medium according to claim 6, wherein said atmospheric plasma treatment is performed as said film moves on a conveyer having an average speed between about 100 ft/minute and 1000 ft/minute.

11. A magnetic recording medium according to claim 6, wherein said atmospheric plasma treatment uses at least one gas selected from helium, oxygen, CO₂, N₂, ammonia, and mixtures thereof.

12. A magnetic recording medium according to claim 6, wherein said magnetic layer comprises magnetic metallic pigment particles having a coercivity of at least about 2000 Oersteds (Oe), said pigment particles having an average particle length of no more than about 100 nm, and a binder system for the pigment.

13. A magnetic recording medium according to claim 12, wherein said binder system comprises a first resin component and a second resin component.

14. A magnetic recording medium according to claim 13, wherein said first resin is a vinyl resin selected from the group consisting of a vinyl chloride resin and a nonhalogenated vinyl resin.

15. A magnetic recording medium according to claim 13, wherein said second resin is a polyurethane resin.

16. A magnetic recording medium according to claim 1, wherein the upper layer comprises a primary ferromagnetic pigment, aluminum oxide, a spherical large particle carbon material, a polyurethane binder, a vinyl chloride binder, a hardener, a fatty acid ester lubricant, and a fatty acid lubricant.

17. A magnetic recording medium according to claim 16, wherein said magnetic recording medium is a magnetic recording tape.

18. A magnetic recording medium according to claim 12, wherein said medium is a multi-layer recording medium further comprising at least one sublayer coated onto said substrate prior to coating said magnetic recording layer.

19. A multi-layer magnetic recording medium according to claim 18, wherein said sublayer comprises a pigment powder selected from a non-magnetic or soft magnetic powder having a coercivity of less than 300 Oe, and a resin binder system therefor.

20. A method of making a magnetic recording medium comprising the steps of
a) providing a polyester film substrate,
b) modifying said polyester film substrate by atmospheric plasma treatment wherein said film exhibiting a contact angle of at least about 20 degrees less than the contact angle of an unmodified polyester film, and
c) subsequently coating said film substrate with at least one coating to form a magnetic recording medium.

21. A method according to claim 20, wherein said atmospheric plasma treatment is performed completely at ambient temperatures.

22. A method according to claim 20, wherein said atmospheric plasma treatment uses at least one gas selected from helium, oxygen, CO₂, N₂, ammonia, and mixtures thereof.

23. A method according to claim 20, wherein said atmospheric plasma treatment is performed as said film moves on a conveyer having an average speed between about 100 ft/minute and 1000 ft/minute.

24. A method according to claim 20, wherein said film is selected from the group consisting of polyethylene terephthalate and polyethylene naphthalate.
